(19) United States
(12) Patent Application Publication
(10) Pub. No.: US 2014/0308030 A1
(43) Pub. Date: Oct. 16, 2014

(54) CIRCUIT ARRANGEMENT FOR SUPPLYING ENERGY TO A FUEL INJECTION VALVE FOR INDUCTIVE HEATING

(71) Applicant: CONTINENTAL AUTOMOTIVE GMBH, HANNOVER (DE)

(72) Inventor: Stephan Bolz, Pfatter (DE)

(21) Appl. No.: 14/353,839

(22) PCT Filed: Oct. 19, 2012
(86) PCT No.: PCT/EP2012/070790

§ 371 Date: Apr. 24, 2014

(30) Foreign Application Priority Data
Oct. 24, 2011 (DE) 102011085085.6

(51) Int. Cl. H05B 3/02

(52) U.S. Cl. CPC H05B 3/02
USPC 392/465

(57) ABSTRACT

A circuit for supplying energy to a fuel injection valve for inductive heating has a capacitor and a first coil in the fuel injection valve together forming a parallel resonant circuit. A first controllable switching element is connected between a first node of the capacitor and a connection point connected to ground. A second controllable switching element is connected between a second node of the capacitor and the connection point. A first diode is connected between the control connection of the first switching element and the second node. A second diode is connected between the control connection of the second switching element and the first node. The control connections of the two switching elements are connected to a positive potential. The first node is connected to the positive potential via a second coil, and the second circuit node is connected to the positive potential via a third coil.

The invention relates to a circuit arrangement for supplying energy to a fuel injection valve for inductive heating, comprising a capacitor, whose first connection forms a first circuit node, and whose second connection forms a second circuit node, comprising a first coil, which is arranged in the fuel injection valve and whose first connection is connected to the first circuit node and whose second connection is connected to the second circuit node and which forms, with the capacitor, a parallel resonant circuit, comprising a first controllable switching element, whose first connection is connected to the first circuit node and whose second connection is connected to a connecting point connected to ground potential, and comprising a second controllable switching element, whose first connection is connected to the second circuit node and whose second connection is connected to the connecting point, comprising a first diode, whose anode is connected to the control connection of the first controllable switching element and whose cathode is connected to the second circuit node, and comprising a second diode, whose anode is connected to the control connection of the second controllable switching element and whose cathode is connected to the first circuit node, wherein the control connections of the two switching elements are connected to the positive potential of a supply source.

This circuit arrangement forms an oscillator, which generates radiofrequency electromagnetic energy in the resonant circuit coil and is known essentially from US 2007/200006 A1. In said document, however, the resonant coil is in the form of a primary winding of a transformer, whose secondary winding, together with a filter capacitor which is connected in series with the secondary winding, is connected in parallel with the solenoid drive of an electromagnetic fuel injection valve, with the series circuit comprising a heating winding and a further filter capacitor also being connected in parallel with said solenoid drive. In this case, the secondary winding of the transformer, the two filter capacitors and the heating winding form a resonant circuit, into which radiofrequency electromagnetic energy is transferred via the transformer in order to convert said energy in the heating winding in conjunction with the ferromagnetic material of the valve housing into heat. The advantage of the complex construction disclosed therein consists in that only two connecting lines need to be passed to the injection valve.

However, the transformer is necessary for the wireless coupling-in of the radiofrequency electromagnetic energy of the oscillator which is required for this purpose, which transformer is very expensive in the case of the required power of approximately 1 kW and the typical values for the frequency of 50 kHz to 100 kHz, especially since said transformer needs to be constructed from a plurality of partially tapped windings, which are additionally insulated from one another. Owing to the skin effect occurring at the high frequencies, the windings additionally need to be manufactured from litz wires with individual wire insulation, so-called RF litz wires, which further increases costs.

In order to avoid the high level of complexity in terms of circuitry for the circuit arrangement according to US 2007/200006 A1, the application DE 10 2010 063 112.4, which has not yet been published, proposes omitting the transformer and instead using the coil of the parallel resonance circuit directly as inductive heating winding. However, this coil, together with the housing of the fuel injection valve, which is intended to be heated inductively by the coil, actually forms a transformer subjected to an ohmic resistance, wherein the conductive housing can be considered to be a secondary winding. This loading results in damping of the oscillation of the parallel resonant circuit, which needs to be compensated for by supplying energy from the supply source. For this, in the prior art, the energy compensating for the losses is supplied to the resonant circuit via a further coil, which is connected to a center tap of the resonant circuit coil or the primary winding of the transformer.

This third connecting line required owing to the center tap nevertheless also requires additional plug-type connections at the control device which contains the electronics and at the injection valve in addition to the connecting cable in the case of the technical implementation in a motor vehicle, however. And it is precisely at these locations that the physical space available is particularly restricted and an additional or larger plug-type connector is undesirable. The implementation of the heating winding using a center tap also results in additional manufacturing costs.

The object of the invention consists in providing a simpler and less expensive circuit arrangement.

The object is achieved in the case of a circuit arrangement of the generic type by virtue of the fact that the first circuit node is connected to the positive potential of a supply source via a second coil and the second circuit node is connected to said positive potential via a third coil.

The essential step consists in the fact that a transformer is completely dispensed with. This is based on the knowledge that the further coil can be replaced, without any notable additional costs, by two smaller coils with the same value, but in each case with half the direct current-carrying capacity. The magnitude of the partial inductances is thus approximately halved. This facilitates the installation of the coils in electronics which are otherwise constructed substantially using SMT (surface mounted technology) and can even result in a reduction in the production costs. The resonant circuit coil is therefore no longer formed with a center tap, but is in the form of a simple coil.

By dividing the further coil into two smaller coils, it is again possible to connect the heating winding, which now consists of an individual winding, to the supply voltage at the two connections of said heating winding without in the process losing the advantages of the resonant polarity reversal.

By suitable selection of the turns number for the coil and of the capacitance of the resonant circuit capacitor, both the resonant frequency and the heating power can be set.

In a development of the invention, a plurality of inductive heating windings are operated in parallel or in series from an electronic circuit. In this case, however, it is necessary to ensure that the total inductance effective for the resonant circuit changes as a result of the parallel or series connection of the heating windings, which possibly makes matching of the resonant capacitance and/or the turns number of the heating windings necessary.

In an advantageous development of the circuit arrangement, the connecting point between the first and second switching elements is connected to ground via a third switching element, with the result that the circuit arrangement can be switched on and off by means of this third switching element.

In a development, instead of the third switching element arranged in the grounding cable, a fourth switching element is introduced into the feed line for the supply voltage. If, in an advantageous embodiment of the fourth switching element, a circuit comprising two transistors arranged in opposition is used instead of a single MOSFET (metal-oxide silicon field-effect transistor), which is only off in one voltage direction owing to the inner substrate diode resulting from the technology used, additional polarity reversal protection function is provided in a simple manner.

This is of particular interest in the case of use in a motor vehicle since; in this case, the supply voltage is generally obtained from the 12 V vehicle electrical distribution system voltages. In the case of faulty installation of the vehicle battery, the polarity of the supply voltage can be reversed, which in turn can result in damage to the transistors. By inserting the second transistor, in the case of incorrect polarity of the supply voltage, an undesired current path through the coils according to the invention and the substrate diodes of the first, second and fourth switching elements, from ground to the supply voltage is prevented from being produced. Care should be taken to ensure that the actuation of the polarity reversal protection circuit takes place with reference to the potential of the supply voltage. This is described in more detail in DE 10 2005 032 085 A1, for example.

The invention will be described in more detail below with reference to exemplary embodiments with the aid of figures, in which:

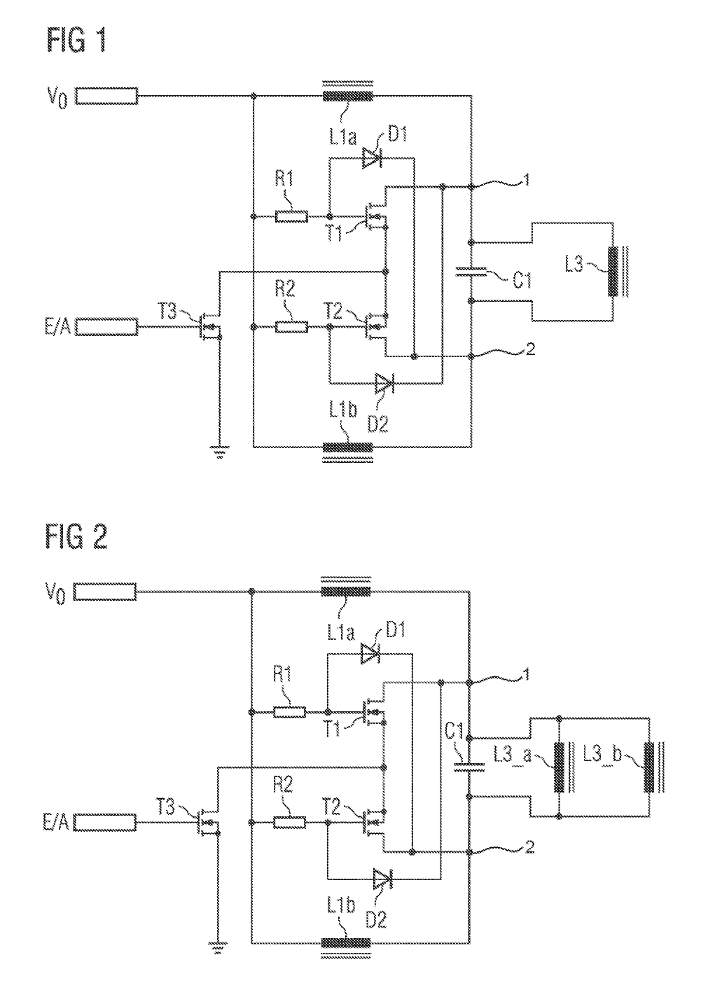

FIG. 1 shows a circuit arrangement according to the invention,

FIG. 2 shows a first development of the circuit arrangement according to the invention, and

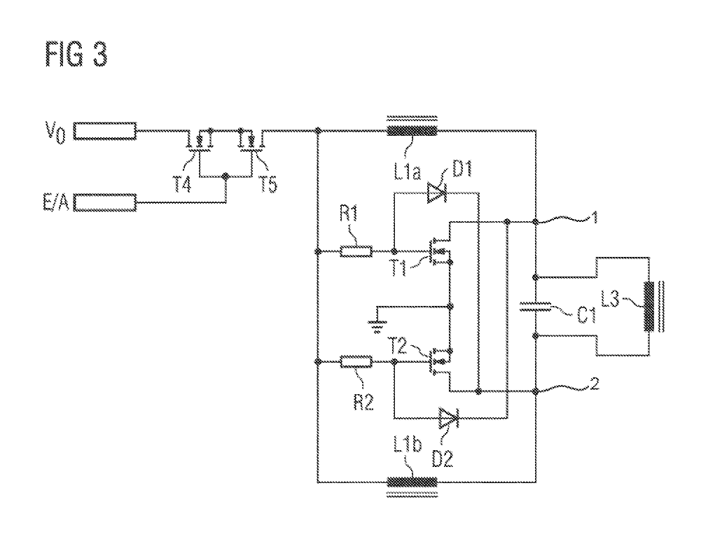

FIG. 3 shows a second development of the circuit arrangement according to the invention.

FIG. 1 shows a circuit arrangement according to the invention for supplying energy to a fuel injection valve for inductive heating, comprising a coil L3 which is arranged in the fuel injection valve and which is connected in parallel with a capacitor C1, wherein the connecting points of the coil L3 and the capacitor C1 form a first circuit node 1 and a second circuit node 2. The series circuit comprising a first switching element T1, which is formed by an n-channel MOSFET, and a second switching element T2, which is likewise formed by an n-channel MOSFET, is arranged between the first circuit node 1 and the second circuit node 2. The connecting point between the two switching elements T1, T1 is connected to the ground potential of a supply source via a third switching element T3, which is formed by an n-channel MOSFET.

The control connection of the third switching element T3 is connected to a control connection E/A for switching on and off the circuit arrangement shown in FIG. 1. The control connections of the first switching element T1 and the second switching element Ts are each connected to the positive potential V₀ of the supply source via a resistor R1 and R2, respectively. In addition, the control connection of the first switching element T1 is connected to the second circuit node 2 via a first diode D1 which is polarized in the forward direction, and the control connection of the second switching element T2 is connected to the first circuit node 1 via a second diode D2 which is polarized in the forward direction.

In order to supply energy to the parallel resonant circuit comprising the coil L3 and the capacitor C1 in order again to replace the energy dissipated in the coil L3 acting as heating winding, the first circuit node 1 is connected to the positive potential V₀ of the supply source via a second coil L1a, and the second circuit node 2 is connected to said positive potential via a third coil L1b.

In the further FIGS. 2 and 3, the same circuit components have been provided with the same reference symbols and will not be described again.

As an extension of the circuit arrangement shown in FIG. 1, FIG. 2 shows a circuit arrangement in which, instead of a resonant circuit coil L3, two resonant circuit coils L3a and L3b which are connected in parallel and which are each arranged in different fuel injection valves are shown. Instead of the parallel circuit, in the same way also a series circuit of the resonant circuit coils can be selected. Care should be taken here to ensure that the total inductance and therefore also the resonant circuit frequency change depending on the number of coils and the way in which they are interconnected, and the inductances thereof need to be selected appropriately.

The third switching element T3, which connects the connecting point of the first and second switching elements to ground potential can also be replaced, as shown in FIG. 3, by a fourth switching element T4, which is likewise in the form of an n-channel MOSFET and is connected between the positive potential of the supply source V₀ and the connections, connected thereto, of the second and third coils L1a, L1b and the control connections of the first and second switching elements T1, T2. It must be borne in mind here that such an n-channel MOSFET needs to be actuated at its control input by a relatively high potential in comparison with the positive potential of the supply source.

As illustrated in FIG. 3, advantageously a fifth switching element T5 can be arranged in series with the fourth switching element T4, wherein said fifth switching element is likewise in the form of an n-channel MOSFET, but is arranged with opposite polarity. Thus, the inverse diodes of these power transistors are arranged with reverse polarity and form an effective polarity reversal protection circuit, with the result that the circuit arrangement shown in FIG. 3 is protected from a case where the motor vehicle battery is inserted with incorrect polarity.

In the circuit arrangement according to the invention, advantageously the third cable for a center tap of the resonant circuit coil L3 can be dispensed with, with the result that it is not necessary for an extra lead through to be provided for this coil arranged in a fuel injection valve. In addition, the two individual coils L1a and L1b can be implemented so as to be smaller than the individual coil known from the prior art, with the result that said coils can possibly be constructed using SMT. This enables simplified circuitry and therefore a cost saving.

1-5. (canceled)

6. A circuit arrangement for supplying energy to a fuel injection valve for inductive heating, the circuit arrangement comprising:
a capacitor having a first connection forming a first circuit node and a second connection forming a second circuit node;
a first coil disposed in the fuel injection valve, said first coil having a first connection connected to said first circuit node and a second connection connected to said second circuit node and said first coil, together with said capacitor, forming a parallel resonant circuit;
a first controllable switching element having a first connection connected to said first circuit node, a second connection connected to a given node connectible to ground, and a control connection connected to a positive potential of a supply source;
a second controllable switching element having a first connection connected to said second circuit node, a second connection connected to said given node, and a control connection connected to a positive potential of a supply source;
a first diode having an anode connected to said control connection of said first controllable switching element and a cathode connected to said second circuit node;
a second diode having an anode connected to said control connection of said second controllable switching element and a cathode connected to said first circuit node;
a second coil connecting said first circuit node to the positive potential of the supply source; and
a third coil connecting said second circuit node to the positive potential of the supply source.

7. The circuit arrangement according to claim 6, which comprises at least one further coil disposed in a further fuel injection valve and connected in parallel or in series with said first coil.

8. The circuit arrangement according to claim 6, which comprises a third switching element connecting said given node between said first and second switching elements to the ground potential.

9. The circuit arrangement according to claim 6, which further comprises a fourth switching element connecting said second coil, said third coil, and said control connections of said first and second switching elements to the positive potential of the supply source.

10. The circuit arrangement according to claim 9, wherein said fourth switching element is an n-channel MOSFET, and further comprising a fifth switching element being an n-channel MOSFET connected in series with said fourth switching element, said fourth and fifth switching elements having source connections connected to one another.
